(19) United States
(12) Patent Application Publication
(10) Pub. No.: US 2010/0224217 A1
(43) Pub. Date: Sep. 9, 2010

(54) SEMICONDUCTOR CLEANING METHOD AND APPARATUS AND CONTROLLING METHOD OF THE SAME

(75) Inventors: Cheng-Hui Chen, Taichung County (TW); Chun-Chieh Wang, Taipei City (TW); Po-Wei Yu, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MACRONIX INTERNATIONAL CO., LTD., Hsinchu (TW)

(21) Appl. No.: 12/399,049

(22) Filed: Mar. 6, 2009

(51) Int. Cl. B08B 7/04

(52) U.S. Cl. 134/18; 134/27; 134/50

(57) ABSTRACT

A semiconductor cleaning method and apparatus and a controlling method of semiconductor cleaning are disclosed. The developing method includes the following steps. A developing solution is applied onto a wafer having a photoresist layer. Next, the wafer is rotated to scatter the developing solution over the photoresist layer. Then, a nozzle upon the center of the wafer ejects a non-reactive liquid onto the photoresist layer for a time period. Next, the nozzle is moved in a radial direction of the wafer to at least one next location and then ejects the liquid onto the photoresist layer for at least one next time period. The wafer is then rinsed until the developing solution and the unnecessary photoresist dissolved in the developing solution are washed away and a patterned photoresist layer is revealed.

### BACKGROUND OF THE INVENTION

1. Field of the Invention

The invention relates in general to a semiconductor cleaning method, and more particularly to a photoresist developing method, a photoresist developing apparatus and a controlling method of developing photoresist.

2. Description of the Related Art

In the fabrication of semiconductor devices such as wafers, many lithography techniques, particularly photolithography technique, have become a standard procedure to form and pattern various layers during a fabrication of a semiconductor device. A common photolithographic operation sequence includes depositing a photoresist layer onto a semiconductor device before exposing selected portions of the photoresist layer to radiation. The photoresist layer is then developed in a developing solution, which dissolves unnecessary photoresist such as the portions exposed to radiation in the case of using a positive one or the portions unexposed to radiation as a negative one is used. After that, the semiconductor device is rinsed to completely remove the developing solution from the semiconductor device. After rinsing, the semiconductor device is usually dried by gas such as nitrogen to remove residual liquid and impurities. Afterward, the subsequent step such as hard baking the photoresist layer is employed before the photolithographic operation is completed, so as to enhance the strength of the photoresist layer.

Nowadays, the quality requirement for the semiconductor devices is getting higher and higher due to the market competition. Every semiconductor manufacturer has been working on improving the structure of the semiconductor devices since every tiny portion of a semiconductor device influences the efficiency of the semiconductor device. However, due to some limitations in conventional semiconductor fabrication, especially in the photolithography process mentioned above, yield is not always satisfactory. For instance, after the developing of a semiconductor device, the photoresist layer is usually accompanied with defects composed of collapsed photoresist structures, which deteriorates the quality of the semiconductor device, and thus affects the manufacturing yield. Therefore, it is needed to develop a semiconductor cleaning method and apparatus to overcome this shortage.

### SUMMARY OF THE INVENTION

It is therefore an object of the invention to provide a semiconductor cleaning method and a semiconductor cleaning apparatus, which effectively maintain a photoresist layer structure in the semiconductor fabrication and thus reduce the number of defects and further increase the manufacturing yield.

The invention achieves the above-identified object by providing a semiconductor cleaning method, which includes the steps stated below. First, a developing solution is applied onto a wafer that has a photoresist layer exposed to radiation in advance. Next, the wafer is rotated to scatter the developing solution over the photoresist layer, so as to dissolve unnecessary photoresist of the photoresist layer evenly. Then, a liquid, which does not react with the photoresist layer and the developing solution, is ejected from a nozzle at a location upon the center of the rotated wafer onto the photoresist layer for a time period. Next, the nozzle is moved in a radial direction of the rotated wafer to at least one next location upon the rotated wafer. Then, the liquid is ejected from the nozzle halted at the at least one next location onto the photoresist layer for at least one next time period. After that, the wafer is rinsed until the developing solution and the unnecessary photoresist dissolved in the developing solution are washed away, so as to reveal a patterned photoresist layer of the wafer.

The invention achieves the above-identified object by further providing a semiconductor cleaning apparatus, which includes a carrier, a developing provider, a rotation driver, a cleaner provider, a motion driver, and a controller. The carrier is used for loading a wafer, wherein the wafer has a photoresist layer that has been exposed to radiation in advance. The developing provider is used for applying a developing solution onto the wafer to dissolve unnecessary photoresist of the photoresist layer. The rotation driver is for rotating the carrier and the wafer thereon to scatter the developing solution over the photoresist layer evenly. The cleaner provider has a nozzle used for ejecting a liquid that does not react with the photoresist layer and the developing solution. The motion driver is used for moving the nozzle. The controller is used for controlling the cleaner provider and the motion driver. After the unnecessary photoresist of the photoresist layer is dissolved in the developing solution, under the control of the controller, the nozzle is moved to a plurality of locations upon the rotated wafer and then ejects the liquid onto the photoresist layer for different time periods.

The invention achieves the above-identified object by further providing a controlling method of semiconductor cleaning. The method comprises the steps of: setting a route of a nozzle used for ejecting a liquid onto a rotated wafer, wherein the route comprises a plurality of locations at which the nozzle is halted; setting a plurality of time periods for the locations at which the nozzle is halted; and, controlling the nozzle to move according to the route and to halt at the locations sequentially for the time periods.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram showing a semiconductor cleaning apparatus according to a preferred embodiment of the invention;

FIG. 2A is a diagram showing a flowchart of a controlling method of semiconductor cleaning according to the preferred embodiment of the invention;

FIG. 2B is a diagram showing a flowchart of a semiconductor cleaning method according to the preferred embodiment of the invention;

FIG. 3A is a diagram showing the movable nozzle halted at different locations upon the wafer;

FIG. 3B is a diagram showing the nozzle halted at the first location upon the wafer;

FIG. 4 is a diagram showing the data curves corresponding to the data in Table 1; and

FIG. 5 is diagram showing the data curves corresponding to the data in Table 2.

### DETAILED DESCRIPTION OF THE INVENTION

A photolithography in semiconductor fabrication usually includes the procedures of coating a photoresist material, exposing the photoresist material to radiation as well as developing a photoresist pattern from the photoresist material. Herein the developing procedure of the photoresist pattern is mainly elaborated, and its relative cleaning procedure is illustrated but the invention is not limited thereto.

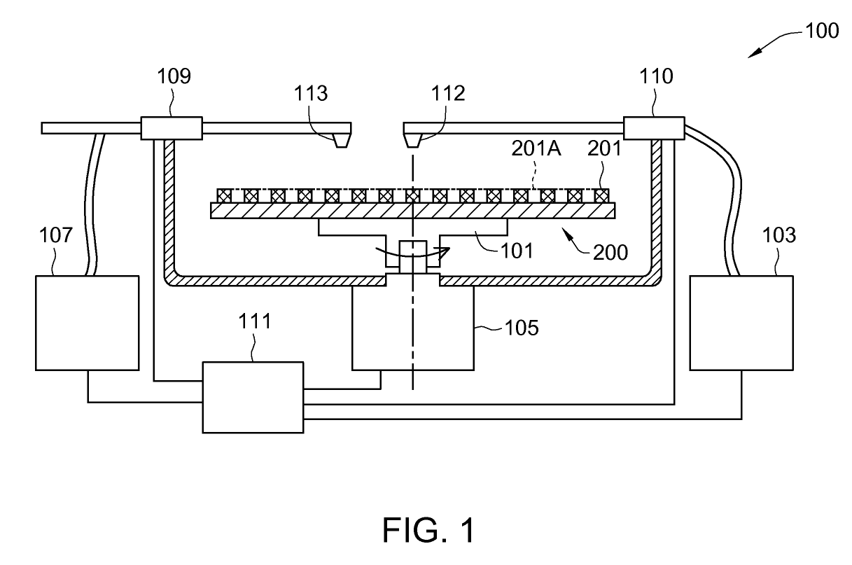

FIG. 1 is a diagram showing a semiconductor cleaning apparatus 100 according to a preferred embodiment of the invention. The semiconductor cleaning apparatus 100 includes a carrier 101, a developing provider 103, a rotation driver 105, a cleaner provider 107, motion drivers 109 and 110, and a controller 111. The carrier 101 is used for loading a wafer 200. For example, the carrier 101 is a disk that provides sufficient suction force to hold the wafer 200. The wafer 200 has a photoresist layer 201 that has been selectively exposed to radiation in advance in order to form a particular photoresist pattern that should be retained on the wafer 200 after a developing procedure to the wafer 200 is performed.

The developing provider 103 is used for applying a developing solution onto the wafer 200. The developing solution is ejected from a nozzle 112, which can be moved by the motion driver 110, onto the wafer 200 to dissolve unnecessary photoresist 201A of the photoresist layer 201. Since the material of the photoresist layer 201 is either a positive type photoresist or a negative type photoresist, the developing solution should be chosen according to the quality of the photoresist layer 201. For example, as the photoresist layer 201 is formed by a positive type photoresist, an alkaline solution is usually used as the developing solution. Preferably, the developing solution is a dilute nonionic alkaline solution.

The rotation driver 105, which connects the carrier 101, is used for rotating the carrier 101 and the wafer 200 thereon, so that the developing solution or other kind of solution applied onto the wafer 200 can be scattered over the photoresist layer 201 evenly. The rotation driver 105 includes, for example, a motor that has a rotating shaft combined with the carrier 101. The cleaner provider 107 is used for supplying the wafer 200 with a cleaner liquid that does not react with the photoresist layer 201 and the developing solution, so as to clean the wafer 200 and retain the photoresist pattern of the wafer 200. The cleaner provider 107 has another nozzle 113 used for ejecting the liquid. Preferably, the liquid for cleaning the wafer 200 is pure water or extra pure water.

The motion driver 109 is used for moving the nozzle 113 to change the location of the nozzle 113 relative to the wafer 200. Preferably, the motion drivers 109 and 110 each include a mechanism that is composed of a plurality of mechanical components such as motor, guide rails, pulleys, belts, gear sets, etc (not shown). In the embodiment, the motion drivers 109 and 110 drive the nozzles 113 and 112 respectively to move in the radial direction of the wafer 200 for example.

The controller 111 is, for example, a programmable controller, and is electrically connected to the developing provider 103, the rotation driver 1051 the cleaner provider 107, and the motion drivers 109 and 110 for controlling the statuses of the above components. By setting specific programs, which are written by computer code for example, in the controller 111 corresponding to different components, each moving locus of the nozzles 109 and 110, the amount of the developing solution provided by the developing provider 103, and the amount of the liquid provided by the cleaner provider 107 can be determined in advance before the developing procedure of the wafer 200 begins. Besides, the sequence of the components to be actuated can also be planned and set in the controller 111 beforehand.

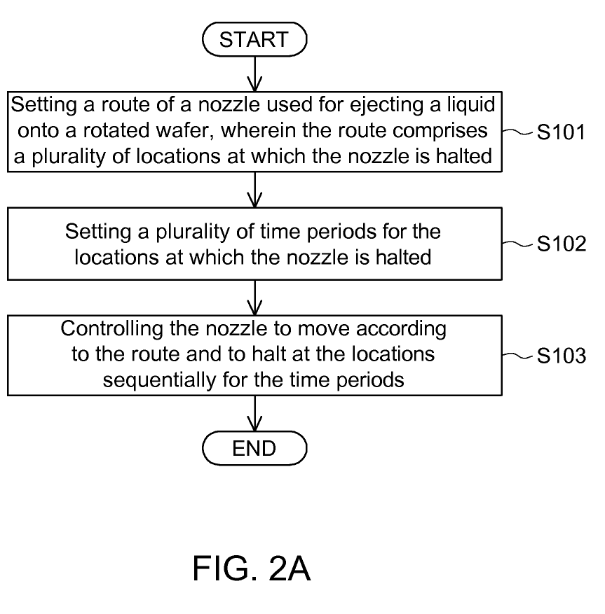

FIG. 2A is a diagram showing a flowchart of a controlling method of developing photoresist according to the preferred embodiment of the invention. The method includes steps S101 to S103. In step S101, a route of a nozzle used for ejecting a liquid onto a rotated wafer is set, wherein the route includes a plurality of locations at which the nozzle is halted. As shown in FIG. 1, the route of the nozzle 113 is, for example, set in the controller 111. Next, as shown in step S102, a plurality of time periods for the locations at which the nozzle is halted are set. The time periods can also be set in the controller 111. Then, as shown in step S103, the nozzle is controlled to move according to the route and to halt at the locations sequentially for the time periods.

Further refer to FIG. 2B. FIG. 2B is a diagram showing a flowchart of a semiconductor cleaning method according to the preferred embodiment of the invention. The semiconductor cleaning method includes steps S201 to S208 elaborated in the following. In the developing procedure, the nozzle is halted at a plurality of locations upon the wafer for different or the same time periods. Herein the nozzle is halted at three different locations upon the wafer for illustration, however the embodiment of the invention is not limited thereto.

In step S201, a developing solution is applied onto a wafer having a photoresist layer exposed to radiation in advance. Normally, in order to obtain a photoresist layer with certain pattern, an opaque or half-transparent mask that has a predetermined pattern is used for covering on a coated photoresist layer when exposing the photoresist layer to radiation. Due to the quality of being sensitive to radiation, the photoresist uncovered by the mask would absorb energy of radiation and then have different reaction to a developing solution. Take a positive photoresist for example. After the positive photoresist is exposed to radiation for a period of time, the exposed positive photoresist becomes soluble to the developing solution and the portion of the photoresist that is not exposed remains insoluble to the developing solution. Therefore, the photoresist layer with certain pattern similar to the predetermined pattern of the mask can be preserved after the developing procedure.

As shown in FIG. 1, before the nozzle 112 ejects the developing solution, the nozzle 112 should be moved to the location corresponding to the center of the wafer 200, so that the developing solution can be dropped through the nozzle 112 down to the center of the wafer 200.

Next, in step S202, the wafer is rotated to scatter the developing solution over the photoresist layer, so as to dissolve unnecessary photoresist of the photoresist layer evenly. As shown in FIG. 1 when the rotation driver 105 rotates the carrier 101 and the wafer 200 thereon, a centrifugal force is generated and applied to the developing solution on the wafer 200, drawing the developing solution to flow from the center of the wafer 200 toward the rim of the wafer 200. Under the rotation of the carrier 101, the developing solution is thus spread over the photoresist layer 201, evenly dissolving the unnecessary photoresist such as the exposed portion of the photoresist layer 201. After a sufficient amount of the developing solution is provided to the wafer 200, the nozzle 112 positioned upon the wafer 200 is moved again via the motion driver 110 back to its initial location such as a location outside the rim of the wafer 200. Afterward, as the unnecessary photoresist is completely dissolved in the developing solution, the rinsing of the wafer 200 should be carried out to clean the wafer 200.

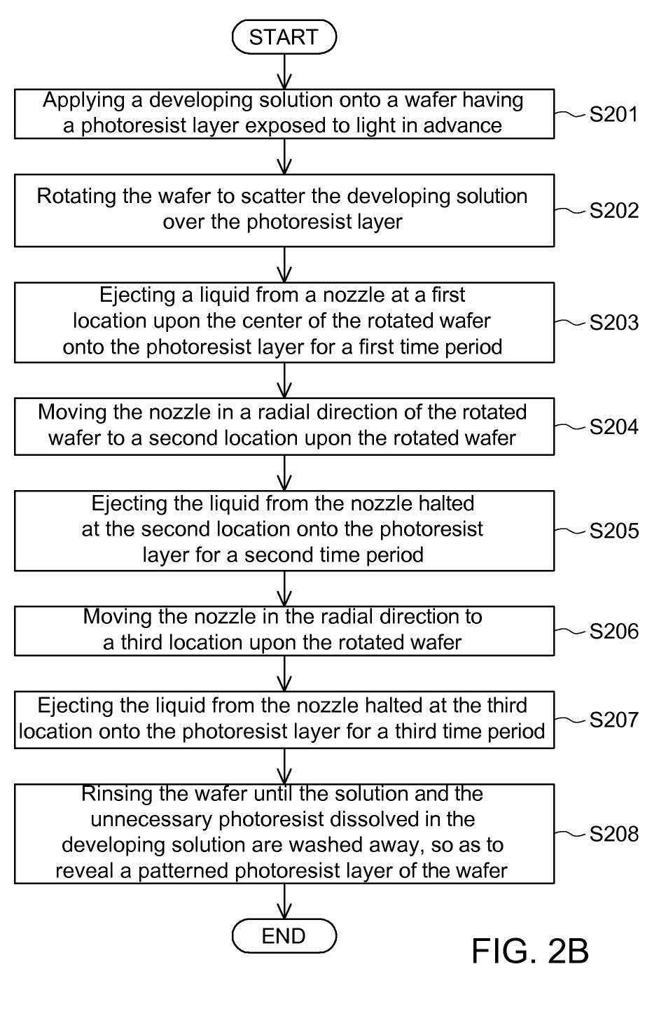

As stated in step S203, a liquid is ejected from a nozzle at a first location upon the center of the rotated wafer onto the photoresist layer for a first time period. FIG. 3A is a diagram showing the movable nozzle 113 halted at different locations upon the wafer 200. Preferably, the nozzle 113 of the cleaner provider 107 starts from the first location P1 corresponding to the center of the wafer 200. The nozzle 113 is halted at the first location P1 for the first time period, wherein the length of the first time period is predetermined and set in the controller 111. The first time period is, for example, about 20 seconds.

During the first time period, the halted nozzle 113 ejects cleaner liquid onto the wafer 200. In the meantime, the wafer 200 is still rotated along with the carrier 101 driven by the rotation driver 105, so the centrifugal force generated during the rotation of wafer 200 draws the cleaner liquid to flow in the direction toward the rim of the wafer 200. As the cleaner liquid flows over the wafer 200, the developing solution and the dissolved photoresist are mixed with the cleaner liquid and are gradually taken away by the cleaner liquid. After the first time period is over, the developing method proceeds to the next step S204.

In step S204, the nozzle is moved in a radial direction of the rotated wafer to a second location upon the rotated wafer. The nozzle 113 is moved at either a constant spend or an inconstant speed. Preferably, the nozzle 113 is moved at a constant speed. During the moving progress toward the second location P2, the ejection of the liquid from the nozzle 113 is continued or ceased, which is predetermined in the controller 111 according to practical requirements for the wafer 200. In the embodiment, the nozzle 113 keeps ejecting liquid when moving to the next location. As arrived at the second location P2, the nozzle 113 is halted, and then the developing method proceeds to the next step S205.

In step S205, the liquid is ejected from the nozzle halted at the second location onto the photoresist layer for a second time period. This step is the same as step S203 however the first and second time periods are not necessary equal in length. In the embodiment, the nozzle 113 is preferably halted at each location for the same time period. That is, the second time period is also about 20 seconds. Similarly, the length of the second time period is determined in advance and set in the controller 111. After the second time period is over, the developing method proceeds to the next step S206.

In step S206, the nozzle is moved in the radial direction again to a third location upon the rotated wafer. After that, as stated in step S207, the liquid is ejected from the nozzle halted at the third location onto the photoresist layer for a third time period. The length of the third time period is the same as that of the first and second time periods. That is, the third time period is about 20 seconds. In the embodiment, the second location P2 is set to be between the first location P1 and the third location P3, however the invention is not limited thereto. The nozzle 113 can also be moved according to other route rather than the route from P1 to P3. The intervals between the first location P1, second location P2 and third location P3 are predetermined in the controller 111. Preferably the distance between the first location P1 and the second location P2 is equal to that of the second location P2 and the third location P3.

As shown in step S208, the wafer is rinsed until the developing solution and the unnecessary photoresist dissolved in the developing solution are washed away, so as to reveal a patterned photoresist layer of the wafer. The route from P1 to P3 can be repeated several times for cleaning the wafer 200 thoroughly. For example, as indicated in FIG. 3A by arrows A1, the nozzle 113 halted at the third location P3 is moved again back to the first location P1 before the next route from P1 to P3 is started. After the nozzle 113 is again positioned at the first location P1, the steps S203 to S207 are repeated. The number of times to move the nozzle 113 following the route from P1 to P3 can be set in the controller 111 in advance based on the requirements for the wafer 200. In other words, the moving locus of the nozzle 113 can also be predetermined in the controller 111 in the form of a program written by computer code such that the motion driver 109 would drive the nozzle 113 following the program set in the controller 111. As the route from P1 to P3 for the nozzle 113 is repeated, each time period for halting the nozzle 113 can be reduced. For example, the nozzle 113 is halted at the first, second, and third locations P1, P2, and P3 each for about 5 seconds, and the route from P1 to P3 is repeated 2 or 3 times.

Since the wafer 200 is continuously rotated when the nozzle 113 ejects the cleaner liquid onto the wafer 200, the generated centrifugal force keeps drawing the cleaner liquid to flow outward, such that the developing solution and the dissolved photoresist are taken away instead of being retained on the wafer 200. In addition, the nozzle 113 ejects the cleaner liquid as halted at the locations P1, P2 and P3 each for a particular time period, the liquid during the whole rinsing procedure is not only sprayed on one portion of the wafer 200 (such as the center of the wafer 200), abating the ejection impact on the photoresist layer 201 of the wafer 200. Moreover, the ejection rate of the liquid from the nozzle 113 and the moving speed of the nozzle 113 are controlled. Based on the above reasons, as the wafer 200 is rinsed, the structure of the patterned photoresist layer is well kept without peeling, largely increasing the manufacturing yield of the wafer 200.

Normally, the total time of a developing procedure in photolithography is the sum of time for applying developing solution, time for letting the photoresist layer 201 react with the developing solution and time for rinsing the wafer 200. Besides, for defeat issue, part of the photoresist layer 201 may need longer rinsing time. Due to the movable nozzle 113 that sprays cleaner liquid at several portions of the wafer 200, the developing time is curtailed, so as to speed up the developing procedure.

After the rinsing procedure of the wafer 200 is completed, the nozzle 113 is normally returned to its beginning location, which is the first location P1 that corresponds to the center of the wafer 200. However, the invention is not limited thereto. The nozzle 113 can also be returned to other location such as a fourth location P4 (shown in FIG. 3A), which is outside the rim of the wafer 200.

For testing, wafers having a plurality of dies are experimented. In the experiments, the rotating speed of the wafers is set to range from 700 rpm to 2000 rpm, each length of the first, second and third time periods is 5 seconds, the distance between the first location P1 and the second location P2 is 5 millimeter (mm), and the distance between the second location P2 and the third location P3 is 10 mm. In addition, the number of times to move the nozzle 113 following the route from P1 to P3 is in the range of 1 to 5, and the total time in rinsing the wafer 200 is less than 60 seconds. For comparison, as shown in FIG. 3B, an experiment in which an unmovable nozzle 113 is positioned at a location (first location P1) corresponding to the center of the wafer during the whole rinsing procedure is taken. Each wafer after experimented is examined for counting the defects, which include the collapse portions on the photoresist layer of the wafer and the destroyed dies, and the numbers of the defects are also recorded. The results of the experiments with different rotating speeds of wafer are recorded in Table 1, and the results of the experiments with different repeating times and constant rotating speed (1000 rpm) are recorded in Table 2. In Tables 1 and 2, “DD” and “DC” both are the experimental data from the experiments according to the embodiment of the invention, wherein “DD” denotes the number of the destroyed dies, and “DC” denotes the number of the defects (individual collapsed portions on the photoresist layer). As for “DC-Base” and “DD-Base”, both are the experimental data from the comparison experiment.

TABLE 1

rotating speed

| | 700 | 800 | 900 | 1000 | 1500 | 2000 |
|---|---|---|---|---|---|---|
| DD | 5.8 | 6.0 | 4.5 | 6.0 | 4.8 | 17.3 |
| DD-Base | 12.0 | 12.0 | 12.0 | 12.0 | 12.0 | 12.0 |
| DC | 15.4 | 26.5 | 18.3 | 16.8 | 5.5 | 18.3 |
| DC-Base | 37.5 | 37.5 | 37.5 | 37.5 | 37.5 | 37.5 |

TABLE 2

| | repeating times | | | | |
|---|---|---|---|---|---|
| | 1 | 2 | 3 | 4 | 5 |
| | total time | | | | |
| | 45 | 48 | 45 | 48 | 45 |
| DD | 7.2 | 4.8 | 5.2 | 6.0 | 7.5 |
| DD-Base | 12.0 | 12.0 | 12.0 | 12.0 | 12.0 |
| DC | 15.4 | 14.0 | 16.4 | 20.8 | 18.3 |
| DC-Base | 37.5 | 37.5 | 37.5 | 37.5 | 37.5 |

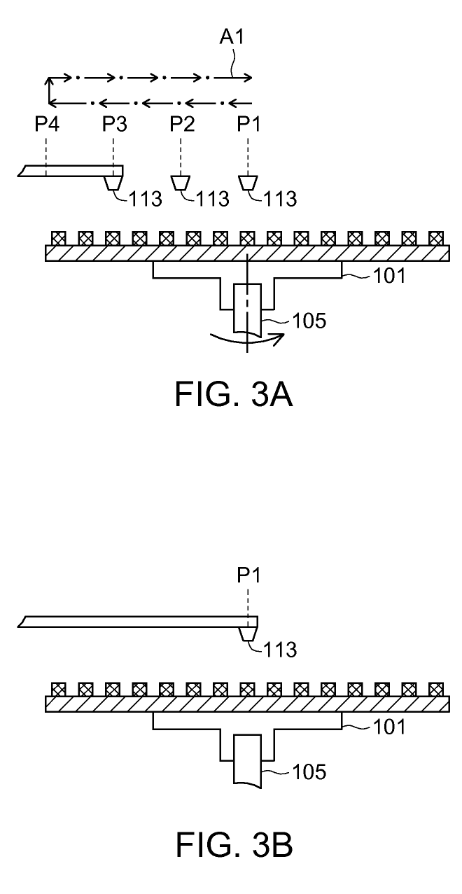

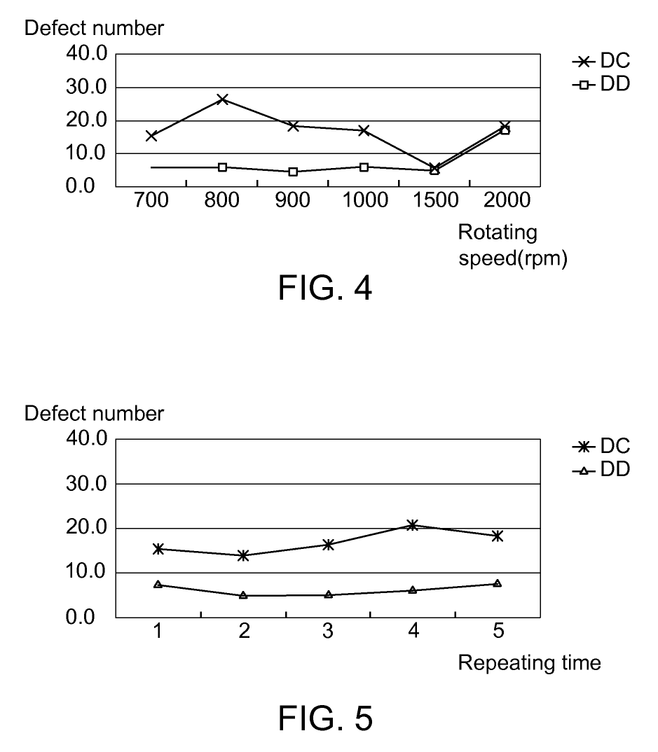

Also refer to FIGS. 4 and 5. FIGS. 4 and 5 are diagrams respectively showing the data curves corresponding to the data in Tables 1 and 2. As shown in FIG. 4 and Table 1, the rotating speed of wafer is preferably less than 2000 rpm since the number (17.3) of the defects in the experiment with 2000 rpm is much greater than that (4.8) of 1500 rpm. And it is noted that, under different rotating speeds, the numbers of the defects for the experiments with movable nozzle are all less than that of the experiments with unmovable nozzle. Take the experiment with 1000 rpm for example. The number of the defects for the experiment with movable nozzle is 16.8, which is much less than the defect number (37.5) of the comparison experiment with unmovable nozzle. As shown in FIG. 5 and Table 2, in each experiment with different repeating time, the number of the defects for the experiment with movable nozzle is also less than the defect number of the experiment with unmovable nozzle. As such, the experimental results have shown that the semiconductor cleaning method and apparatus in the preferred embodiment of the invention do have the ability to manufacture wafers with high quality.

The semiconductor cleaning method and apparatus in the preferred embodiment of the invention can also be used in the cleaning procedure for chemical mechanical polishing/planarization (CMP) as well as other semiconductor fabrication procedures.

The semiconductor cleaning method and apparatus in the preferred embodiment of the invention make use of a dynamic way to control a nozzle used for ejecting cleaner liquid, so the moving locus of the nozzle is more flexible than what is used in conventional apparatus and method. And, since the nozzle is able to spray cleaner liquid onto different portions of a wafer during the rinsing procedure, the ejection of the cleaner liquid is not concentrated on the same portion of the photoresist layer of the wafer, thereby abating the ejection impact on the photoresist layer and reducing the rinsing time, further lowering possibility of damaging the structure of the photoresist layer. Besides, the wafer is rotated as the cleaner liquid is sprayed from the nozzle, so the cleaner liquid is drawn to flow outward under the centrifugal force, easily washing away the developing solution and the dissolved photoresist, enhancing the efficiency of rinsing the wafer. Based on the above experimental results, the semiconductor cleaning method and apparatus in the preferred embodiment of the invention indeed reduce the number of defects occurred in the wafer, effectively increasing the manufacturing yield in semiconductor fabrication.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A semiconductor cleaning method, comprising the steps of:
applying a developing solution onto a wafer having a photoresist layer exposed to radiation in advance;
ejecting a liquid from a nozzle at a location upon the center of the rotated wafer onto the photoresist layer for a time period, wherein the liquid does not react with the photoresist layer and the developing solution;
moving the nozzle in a radial direction of the rotated wafer to at least one next location upon the rotated wafer;
ejecting the liquid from the nozzle halted at the at least one next location onto the photoresist layer for at least one next time period; and
rinsing the wafer until the developing solution and the unnecessary photoresist dissolved in the developing solution are washed away, so as to reveal a patterned photoresist layer of the wafer.

2. The method according to claim 1, wherein the location upon the center of the rotated wafer is a first location, the nozzle is halted at the first location for a first time period, and the nozzle is further halted at a second location and a third location for a second time period and a third time period, respectively.

3. The method according to claim 2, wherein the second location is between the first location and the third location.

4. The method according to claim 2, wherein each length of the first, second and third time periods is about 20 seconds.

5. The method according to claim 2, wherein the number of times to move the nozzle following the route from the first location to the third location is in the range of 2 to 5.

6. The method according to claim 2, further comprising the steps of:
moving the nozzle from the third location back to the first location; and
repeating the step of ejecting the liquid from the nozzle at the first location onto the photoresist layer for the first time period.

7. A semiconductor cleaning apparatus, comprising:
a carrier for loading a wafer having a photoresist layer, wherein the photoresist layer has been exposed to radiation in advance;
a developing provider for applying a developing solution onto the wafer;
a rotation driver for rotating the carrier and the wafer thereon to scatter the developing solution over the photoresist layer evenly;
a cleaner provider having a nozzle to eject a liquid, wherein the liquid does not react with the photoresist layer and the developing solution;
a motion driver for moving the nozzle; and
a controller for controlling the cleaner provider and the motion driver, wherein after the unnecessary photoresist of the photoresist layer is dissolved in the developing solution, under the control of the controller, the nozzle is moved to a plurality of locations upon the rotated wafer and then ejects the liquid onto the photoresist layer for different time periods respectively.

8. The apparatus according to claim 7, wherein the controller is a programmable controller.

9. The apparatus according to claim 7, wherein a first, second and third locations are predetermined in the controller, the first location is upon the center of the wafer, and the second location is between the first location and the third location.

10. The apparatus according to claim 9, wherein each length of the time periods that the nozzle is halted is about 20 seconds.

11. The apparatus according to claim 9, wherein the number of times to move the nozzle following the route from the first location to the third location is in the range of 2 to 5.

12. The apparatus according to claim 9, wherein under the control of the controller, the nozzle halted at the third location is moved back to the first location and then ejects the liquid onto the photoresist layer.

13. A controlling method of semiconductor cleaning, comprising the steps of:
setting a route of a nozzle used for ejecting a liquid onto a rotated wafer, wherein the route comprises a plurality of locations at which the nozzle is halted;
setting a plurality of time periods for the locations at which the nozzle is halted; and
controlling the nozzle to move according to the route and to halt at the locations sequentially for the time periods.

14. The method according to claim 13, wherein the route comprises a first location, a second location, and a third location along a radial direction of the rotated wafer, and the second location is between the first location and the third location.

15. The method according to claim 14, wherein the nozzle is halted at the first, second and third locations for a first, second and third time periods, respectively.

16. The method according to claim 15, wherein each length of the first, second and third time periods is about 20 seconds.

17. The method according to claim 14, wherein the number of times to move the nozzle following the route from the first location to the third location is in the range of 2 to 5.

18. The method according to claim 14, further comprising the steps of:
moving the nozzle from the third location back to the first location; and
ejecting the liquid from the nozzle at the first location onto the rotated wafer.
